(19) United States
(12) Patent Application Publication
(10) Pub. No.: US 2023/0087067 A1
(43) Pub. Date: Mar. 23, 2023

(54) ALTERNATOR AND SLIP RING ASSOCIATED WITH ALTERNATOR

(71) Applicant: Caterpillar Inc., Peoria, IL (US)

(72) Inventors: GOPALAKRISHNAN KANNIAPPAN, TIRUVANNAMALAI (IN); CHANDANA RAMKUMAR, COIMBATORE (IN)

(73) Assignee: Caterpillar Inc., Peoria, IL (US)

(21) Appl. No.: 17/482,577

(22) Filed: Sep. 23, 2021

(51) Int. Cl. H02K 13/00; H02K 5/14; H02K 7/18; H02K 15/00; H01R 39/08

(52) U.S. Cl. CPC H02K 13/003; H02K 5/141; H02K 7/1815; H02K 15/00; H01R 39/08

(57) ABSTRACT

An alternator includes a housing and a rotary shaft. The alternator includes one or more brushes supported by the housing. The alternator includes a slip ring assembly coupled to the rotary shaft for rotating with the rotary shaft. The slip ring assembly includes one or more slip rings. The one or more slip rings include a body portion defining an outer surface. The one or more slip rings also include an oxide layer disposed on the outer surface of the body portion. The oxide layer is non-uniform. The oxide layer is formed on account of a thermal oxidation process of the one or more slip rings during an operation of the alternator. Further, the thermal oxidation process for formation of the oxide layer initiates when an operating temperature of one or more components of the alternator lies within a predetermined temperature threshold range.

### TECHNICAL FIELD

The present disclosure relates to an alternator and a slip ring assembly associated with the alternator.

### BACKGROUND

Typically, alternators are associated with various movable or stationary machines to convert mechanical energy into electrical energy. The alternators typically include a rotating part i.e., a rotor assembly and a stationary part i.e., a stator assembly. For electrical contact between the rotor assembly and a power source, the alternator includes one or more brushes that slidably contact one or more slip rings disposed on a rotary shaft of the alternator.

The sliding contact between the brushes and the slip rings may cause wear and tear of the brushes at a contact surface of the brushes due to friction. This phenomenon may continuously erode the brushes which may affect a performance of the alternator and may also reduce a life span of the brushes. Further, damage to the brushes may warrant a replacement of the brushes, thereby increasing a cost and efforts related to the replacement of the brushes. Furthermore, as the brushes erode, the alternator may fail to produce electricity thereby increasing a downtime associated with the alternator. Thus, a solution may be desired to address the abovementioned challenges in order to reduce replacement efforts, replacement costs, and a downtime of the alternators, while increasing an efficiency of the alternators.

European Patent Application Number 2,4267,93 describes an abrasive ring brush system for current controlled synchronous motor rotor. The abrasive ring brush system has slip rings fastened to a rotor, and brushes arranged in a rotatably fixed part. The slip rings are formed at a rigid printed circuit board and united with the board by an insulating casing to form an integrated slip ring unit. The slip rings are arranged coaxially and at a radial distance from each other, and in cooperation with each of the brushes. The brushes are oriented in an axial direction of the rotor. The ring unit is fastened to a front side of the rotor in a torsionally stiff manner, and to a support ring that supports a winding head of the rotor.

### SUMMARY OF THE DISCLOSURE

In one aspect of the present disclosure, an alternator is provided. The alternator includes a housing. The alternator also includes a rotary shaft supported by the housing. The alternator further includes one or more brushes supported by the housing and radially spaced apart from the rotary shaft. The alternator includes a slip ring assembly coupled to the rotary shaft for rotating with the rotary shaft. The slip ring assembly includes one or more slip rings, such that the one or more brushes slidably contact the one or more slip rings. The one or more slip rings include a body portion defining an outer surface. The one or more slip rings also include an oxide layer disposed on the outer surface of the body portion. The oxide layer is non-uniform. The oxide layer is formed on account of a thermal oxidation process of the one or more slip rings during an operation of the alternator. Further, the thermal oxidation process for formation of the oxide layer initiates when an operating temperature of one or more components of the alternator lies within a predetermined temperature threshold range.

In another aspect of the present disclosure, a slip ring assembly associated with an alternator is provided. The slip ring assembly includes one or more slip rings. The one or more slip rings include a body portion defining an outer surface. The one or more slip rings also include an oxide layer disposed on the outer surface of the body portion. The oxide layer is non-uniform. The oxide layer is formed on account of a thermal oxidation process of the one or more slip rings during an operation of the alternator. Further, the thermal oxidation process for formation of the oxide layer initiates when an operating temperature of one or more components of the alternator lies within a predetermined temperature threshold range.

In yet another aspect of the present disclosure, a method of forming an oxide layer on one or more slip rings of an alternator is provided. The alternator includes one or more brushes that slidably contact the one or more slip rings. The method includes actuating the alternator to increase an operating temperature of one or more components of the alternator. The method also includes forming the oxide layer on an outer surface of a body portion of the one or more slip rings. The oxide layer is non-uniform. The oxide layer is formed on account of a thermal oxidation process of the one or more slip rings during an operation of the alternator. Further, the thermal oxidation process for formation of the oxide layer initiates when the operating temperature of the one or more components of the alternator lies within a predetermined temperature threshold range.

Other features and aspects of this disclosure will be apparent from the following description and the accompanying drawings.

### BRIEF DESCRIPTION OF THE DRAWINGS

FIG. 1 illustrates a partial cross sectional view of an alternator, according to examples of the present disclosure;

FIG. 2 illustrates an exploded view of a slip ring assembly, a rotary shaft, and a rotor assembly associated with the alternator of FIG. 1, according to examples of the present disclosure;

FIG. 3 illustrates a schematic view of a slip ring associated with the slip ring assembly of FIG. 2, according to a first example of the present disclosure;

FIG. 4 illustrates a schematic view of a number of conducting spots formed on the oxide layer of the slip ring of FIG. 2, according to the first example of the present disclosure;

FIG. 5 illustrates a schematic view of a current transfer passage defined in the oxide layer of FIG. 4, according to the first example of the present disclosure;

FIG. 6 illustrates a schematic view of another slip ring associated with the alternator of FIG. 1, according to a second example of the present disclosure; and

FIG. 7 illustrates a flowchart for a method of forming the oxide layer on one or more slip rings of the alternator, according to examples of the present disclosure.

### DETAILED DESCRIPTION

Wherever possible, the same reference numbers will be used throughout the drawings to refer to the same or the like parts. Wherever possible, corresponding or similar reference numbers will be used throughout the drawings to refer to the same or corresponding parts.

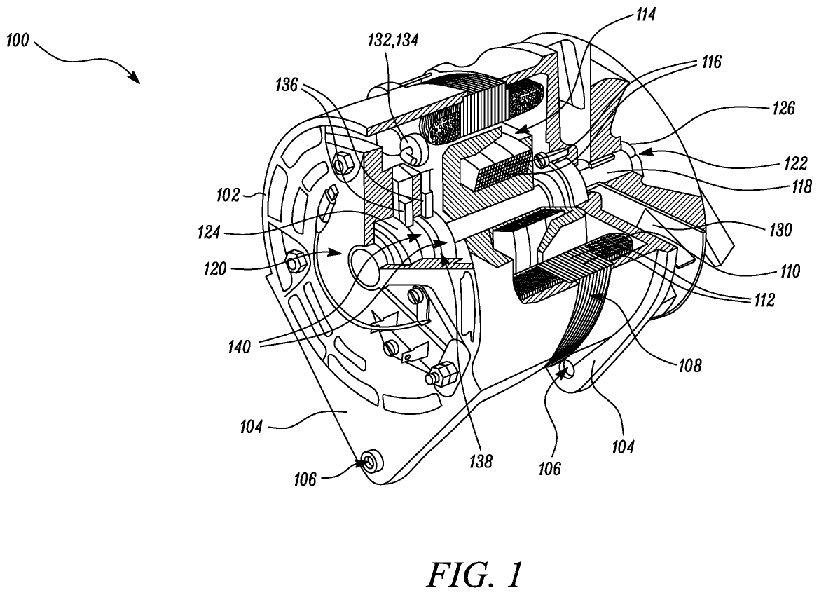

FIG. 1 illustrates a partial cross sectional view of an alternator 100. The alternator 100 may be associated with a machine (not shown). The machine may include a stationary machine, a movable machine, and so on, based on application requirements. In some examples, the machine may include a construction machine. The machine may include a power source (not shown), such as, an engine that generates mechanical energy. The engine may include, but not limited to, a diesel engine, a gasoline engine, a gaseous fuel powered engine, a dual fuel powered engine, and/or a combination thereof, based on application requirements.

In the illustrated example of FIG. 1, the alternator 100 may generate electrical energy in the form of a direct current. More particularly, the alternator 100 may be operatively coupled to the engine via a drive train (not shown) of the machine. The alternator 100 may convert the mechanical energy generated by the engine to electrical energy. The electrical energy may be supplied to one or more components of the machine for operation thereof. Further, the alternator 100 may also be used to charge one or more batteries (not shown) disposed within the machine.

The alternator 100 includes a housing 102. The housing 102 includes a hollow cylindrical shaped structure. The housing 102 of the alternator 100 may be manufactured using a metal or alloys. The housing 102 may allow mounting and support of one or more components of the alternator 100. The housing 102 of the alternator 100 includes one or more flanges 104 including one or more through-holes 106 to receive mechanical fasteners (not shown). The housing 102 of the alternator 100 may be coupled to a portion of the machine via the flanges 104. In some examples, the housing 102 of the alternator 100 may be welded to the machine, without any limitations.

The alternator 100 also includes a stator assembly 108. The stator assembly 108 is embodied as a stationary component of the alternator 100. The stator assembly 108 includes a circular shape. The stator assembly 108 is mounted concentrically within the housing 102. The stator assembly 108 includes a number of laminated sheets 110 defining a number of slots (not shown) around a periphery of the stator assembly 108. The stator assembly 108 also includes a number of stator windings 112 wrapped around the slots. The stator windings 112 may be electrically coupled to each other to form a star configuration. Further, each stator winding 112 may produce a single phase alternating current. In an example, the stator assembly 108 may include three stator windings 112 to produce three phase alternating current. In should be noted that a total number of the stator windings 112 do not limit the scope of the present disclosure.

The alternator 100 further includes a rotor assembly 114. The rotor assembly 114 rotates with respect to the stator assembly 108. The rotor assembly 114 has a generally circular shape. The rotor assembly 114 is supported by the housing 102. The rotor assembly 114 includes a number of rotor windings 116. The rotor windings 116 may be mounted concentrically within the stator windings 112. Further, the rotor windings 116 may control a voltage of the alternating current by varying a current in the rotor windings 116. The rotor assembly 114 may also include one or more permanent magnets (not shown). The rotor windings 116 and the permanent magnets may together produce a rotating magnetic field. Further, the rotating magnetic field of the rotor assembly 114 may cut across the stator assembly 108 which may in turn generate an induced electromotive force (EMF). The induced EMF in turn produces the alternating current which may be supplied to the one or more components of the machine and/or the batteries.

The alternator 100 includes a rotary shaft 118 supported by the housing 102. The rotary shaft 118 is disposed concentrically within the rotor assembly 114 and fixedly coupled to the rotor assembly 114 such that the rotor assembly 114 rotates the rotary shaft 118. The rotary shaft 118 defines a front end 120 and a rear end 122. The rotary shaft 118 is supported at the front end 120 by a front bearing 124. Further, the rotary shaft 118 is supported at the rear end 122 by a rear bearing 126. At the front end 120, the rotary shaft 118 is coupled to a pulley (not shown). The pulley receives the mechanical energy through the drive train. The drive train may include a belt drive. The belt drive may include a belt (not shown) to operatively couple the pulley with the engine. The rotary shaft 118 may also support the rotor winding 116, heat sinks (not shown), and a cooling fan 130, which may be mounted within the housing 102. Further, the rotor assembly 114 and the heat sinks may be keyed to the rotary shaft 118 in order to maintain a rigid angular orientation. The cooling fan 130 may be used to dissipate heat generated during an operation of the alternator 100.

The alternator 100 also includes a rectifier 132 to convert the alternating current into the direct current. The alternator 100 further includes a regulator 134 to maintain a constant output of the direct current. The one or more components of the machine may utilize the direct current at a particular voltage and a particular frequency for operation thereof.

The alternator 100 includes one or more brushes 136 supported by the housing 102 and radially spaced apart from the rotary shaft 118. The brushes 136 establish an electrical contact between the power source and the rotor assembly 114. In the illustrated example of FIG. 1, the alternator 100 includes two brushes 136. The brushes 136 define a sliding surface (not shown). The sliding surface of the brushes 136 may include a generally curved profile. The brushes 136 may embody a spring loaded brush. Further, in the illustrated example of FIG. 1, a material of the one or more brushes 136 is graphite. In other examples, the brushes 136 may be made of any material and a coating of graphite may be provided on the brushes 136. Further, the brushes 136 may be made from other materials, such as, carbon graphite, electrographite, and metal graphite, without limiting the scope of the present disclosure.

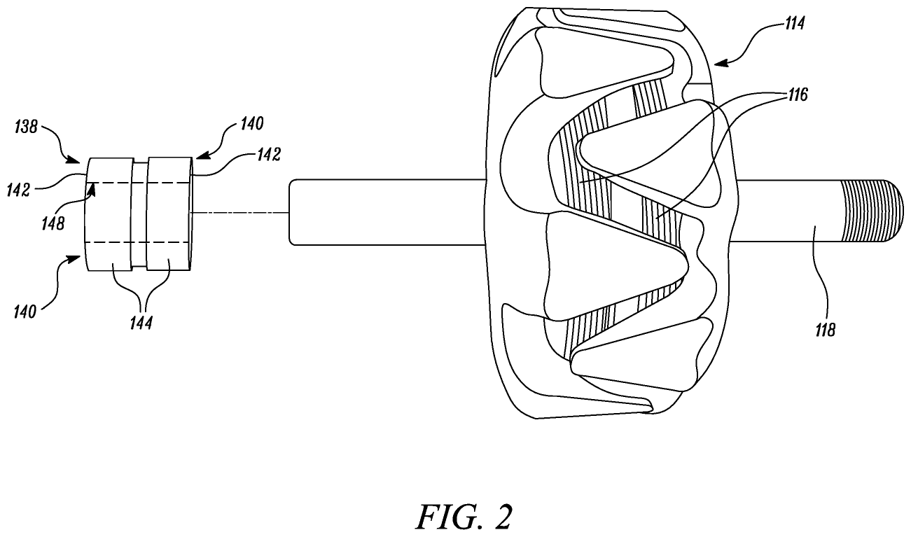

Referring to FIG. 2, the alternator 100 (see FIG. 1) includes a slip ring assembly 138 coupled to the rotary shaft 118 for rotating with the rotary shaft 118. The slip ring assembly 138 associated with the alternator 100 includes one or more slip rings 140, such that the one or more brushes 136 (see FIG. 1) slidably contact the one or more slip rings 140. Specifically, the alternator 100 includes two slip rings 140 that are identical in shape and dimensions.

The one or more slip rings 140 include a body portion 142 defining an outer surface 144. The body portion 142 of the slip rings 140 include a generally hollow cylindrical shaped structure. Further, the outer surface 144 defines a circumferential surface of the slip ring 140. The slip rings 140 are disposed on the rotary shaft 118 and electrically coupled to opposite ends of the rotor windings 116 of the rotor assembly 114. Specifically, the slip ring assembly 138 includes a through aperture 148 for receiving a portion of the rotary shaft 118 for mounting the slip ring assembly 138 on the rotary shaft 118.

In the illustrated example of FIG. 2, a material of the one or more slip rings 140 is alloyed steel. In an exemplary embodiment, a composition of the alloyed steel may include 0.15% to 0.2% carbon, 0.1% to 0.4% silicon, 0.5% to 0.8% manganese, 1.2% to 1.6% chromium, 1.2% to 1.6% nickel, 0.1% to 0.3% molybdenum, 95% steel, and traces of phosphor. It should be noted that the composition of the alloyed steel disclosed herein is exemplary in nature, and the composition may vary, as per application requirements.

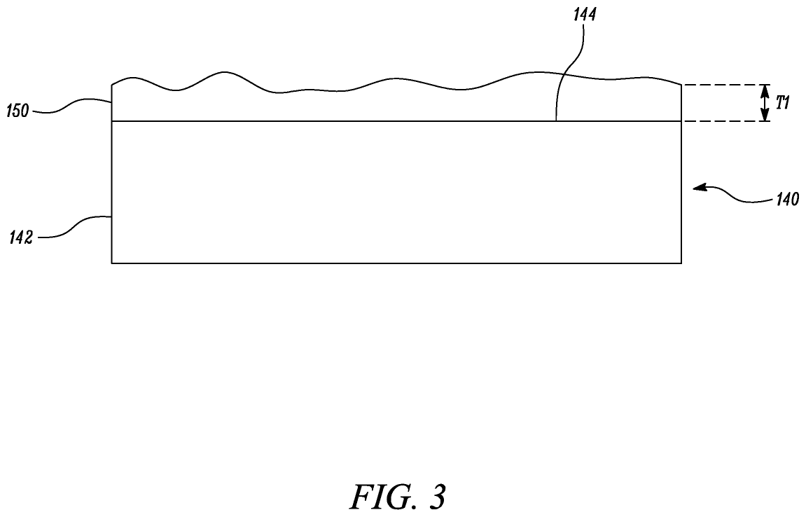

FIG. 3 illustrates a schematic view of the slip ring 140, according to an example of the present disclosure. The one or more slip rings 140 include an oxide layer 150 disposed on the outer surface 144 of the body portion 142. The oxide layer 150 is formed of a chemical compound that may contain an oxygen atom and other elements, such as, iron, manganese, chromium, nickel, molybdenum, and the like. Further, the oxide layer 150 is non-uniform. More particularly, the oxide layer 150 includes a non-uniform thickness “T1”.

The oxide layer 150 is formed on account of a thermal oxidation process of the one or more slip rings 140 during the operation of the alternator 100 (see FIG. 1). The thermal oxidation process for formation of the oxide layer 150 initiates when an operating temperature of one or more components of the alternator 100 lies within a predetermined temperature threshold range “R1”. In an example, the one or more components of the alternator 100 may include the one or more slip rings 140. More particularly, during the operation of the alternator 100, heat may be generated based on operation of various components of the alternator 100. Further, the head generated may increase the operating temperature of the one or more components of the alternator 100. In some examples, the contact of the brushes 136 (see FIG. 1) with the slip rings 140 may contribute to the increase in the operating temperature of the alternator 100. The generated heat forms a favorable temperature condition within the alternator 100 for initiation of the thermal oxidation process of the slip rings 140. In some examples, the predetermined temperature threshold range “R1” may lie from about 55° Celsius to about 95° Celsius. For example, when the operating temperature of the one or more slip rings 140 may be between 55° Celsius and 95° Celsius, the oxygen atom may react with one or more elements in the alloyed steel to form the oxide layer 150 on the outer surface 144 of the body portion 142.

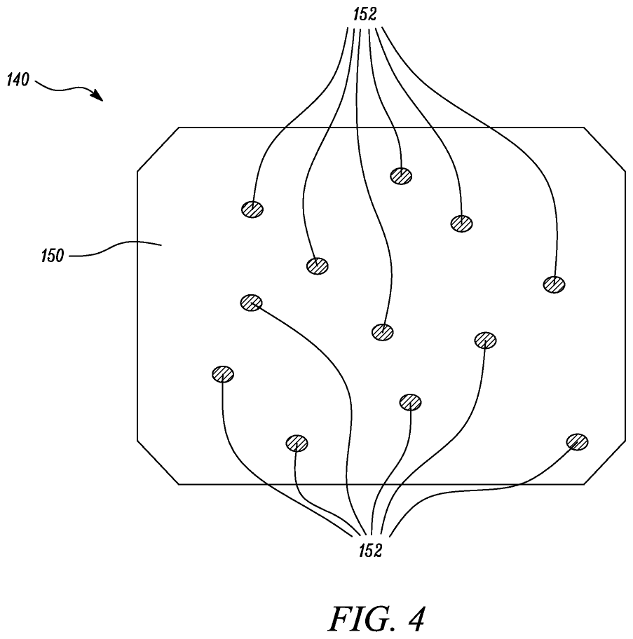

When the operating temperature is within the predetermined temperature threshold range “R1”, the thermal oxidation process of the body portion 142 initiates. The oxide layer 150 is formed gradually on the outer surface 144 of the body portion 142. As shown in FIG. 4, as the thermal oxidation process is naturally initiated, the thickness “T1” (see FIG. 3) of the oxide layer 150 formed on the outer surface 144 of the body portion 142 is non-uniform throughout the outer surface 144 and may not be controlled. Specifically, some regions of the oxide layer 150 may be thinner as compared to other regions. Accordingly, the oxide layer 150 includes one or more conducting spots 152. More particularly, the thinner regions of the oxide layer 150 may be weak and fragile which may lead to formation of the one or more conducting spots 152 on the oxide layer 150.

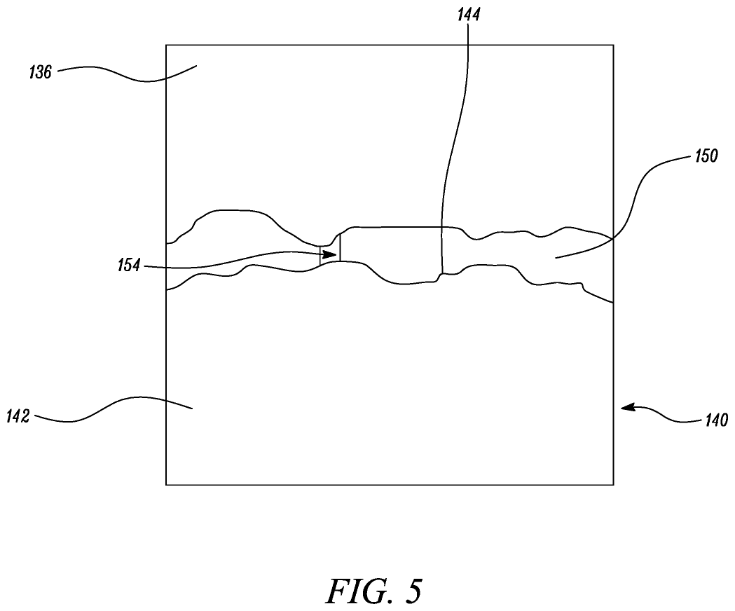

As shown in FIG. 5, the oxide layer 150 also includes one or more current transfer passages 154 (only one current transfer passage 154 is illustrated herein). More particularly, a force exerted on the one or more conducting spots 152 based on a sliding contact between the one or more brushes 136 and the one or more slip rings 140 causes a formation of the one or more current transfer passages 154. More particularly, when the brushes 136 slide over a corresponding slip ring 140, a shear force acts on the oxide layer 150. When the shear forces are exerted on the conducting spots 152, the conducting spots 152 may break down to form the current transfer passages 154 in the oxide layer 150. The current transfer passages 154 may be formed at a location of the conducting spots 152. It should be noted that the oxide layer 150 may be electrically non-insulating, thus formation of the current transfer passage 154 may electrically connect the brushes 136 and the slip rings 140.

Further, the conducting spots 152 may be temporary and new conducting spots 152 may constantly form and erode due to the sliding contact between the brushes 136 and a corresponding slip ring 140 to form the current transfer passages 154. Accordingly, an electrical connection between the brushes 136 and the slip rings 140 may occur through the current transfer passage 154 formed due to the conducting spots 152.

Thus, a combination of the oxide layer 150 on the slip rings 140 and the brushes 136 made of the graphite material may improve a wear resistance and strength of the brushes 136. Accordingly, the oxide layer 150 may provide a dual purpose, i.e., the oxide layer 150 may act as a protective coating on the corresponding slip ring 140 and the current transfer passages 154 in the corresponding oxide layer 150 may allow transfer of the electric current therethrough.

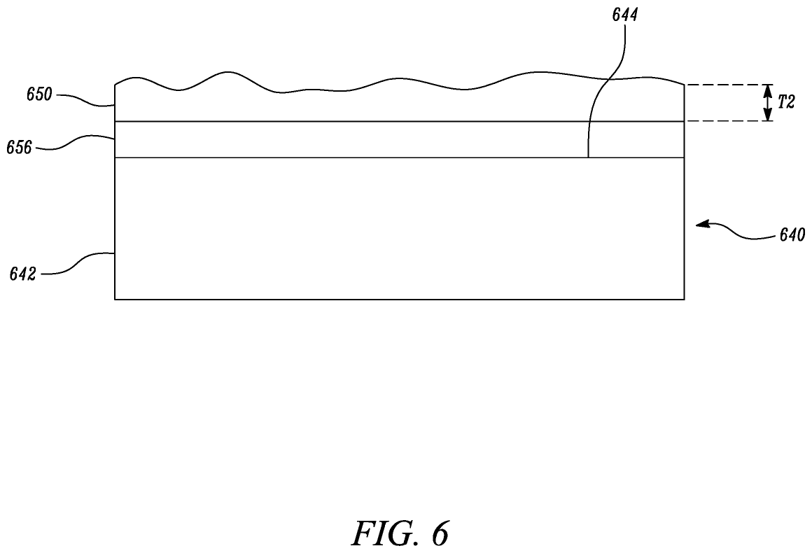

FIG. 6 illustrates a schematic view of another slip ring 640 associated with a slip ring assembly 638, according to another example of the present disclosure. The slip ring assembly 638 may be associated with the alternator 100 (see FIG. 1). The slip ring 640 includes a body portion 642 similar to the body portion 142 of the slip ring 140 explained in relation to FIG. 2. Further, the body portion 642 defines an outer surface 644 similar to the outer surface 144 of the body portion 142 explained in relation to FIG. 2. In the illustrated example of FIG. 6, a material of the one or more slip rings 640 is carbon steel. Further, the body portion 642 includes a coating 656 disposed on the outer surface 644 of the body portion 642, such that an oxide layer 650 is formed on the coating 656. Moreover, a material of the coating 656 is copper. The coating 656 on the outer surface 644 of the body portion 642 enables a formation of the oxide layer 650. It should be noted that the coating 656 may be provided on the outer surface 644 of the body portion 642 by any known coating process, such as spray coating, electroplating, and the like. Further, the oxide layer 650 being formed is copper oxide. Moreover, the oxide layer 650 is non-uniform. More particularly, the oxide layer 650 includes a non-uniform thickness “T2”.

The oxide layer 650 is formed on account of a thermal oxidation process of the coating 656 during the operation of the alternator 100. The thermal oxidation process for formation of the oxide layer 650 initiates when an operating temperature of the one or more components of the alternator 100 lies within a predetermined temperature threshold range “R2”. In an example, the one or more components of the alternator 100 may include the one or more slip rings 640. More particularly, heat may be generated based on operation of various components of the alternator 100. Further, the head generated may increase the operating temperature of the one or more components of the alternator 100. In some examples, the contact of the brushes 136 (see FIG. 1) with the slip rings 640 may also contribute to the increase in the operating temperature of the alternator 100. The generated heat forms a favorable temperature condition within the alternator 100 for initiation of the thermal oxidation process of the coating 656. In some examples, the predetermined temperature threshold range “R2” may lie from about 125° Celsius to about 155° Celsius. Specifically, when the operating temperature is between 125° Celsius and 155° Celsius, the oxygen atom may react with copper in the coating 656 to form the oxide layer 650 on the outer surface 644 of the body portion 642.

Further, in the illustrated example of FIG. 6, a mechanism for establishing an electrical connection between the one or more brushes 136 and the one or more slip rings 640 is similar to that explained in relation to FIGS. 4 and 5. More particularly, the oxide layer 650 may include one or more conducting spots (not shown) similar to the conducting spots 152 explained in relation to FIG. 4. Moreover, the oxide layer 650 may also include one or more current transfer passages (not shown) similar to the current transfer passages 154 explained in relation to FIG. 5. The current transfer passages in the oxide layer 650 may establish the electrical connection between the brushes 136 and the slip ring 640.

### INDUSTRIAL APPLICABILITY

The present disclosure relates to the alternator 100 and a method 700 of forming the oxide layer 150, 650 on the slip ring 140, 640 of the alternator 100. Further, the brushes 136 described herein are made of graphite. The graphite may act as a solid lubricant between the sliding surface of the brushes 136 and the slip rings 140, 640. Moreover, a lamellar structure of the graphite may reduce a friction between the brushes 136 and the slip rings 140, 640.

Further, the oxide layers 150, 650 are embodied as protective coatings that may minimize the wear and tear of the brushes 136 and the slip rings 140, 640 by reducing the friction between the slip rings 140, 640 and the brushes 136. The oxide layer 150, 650 may also increase a life span of the slip rings 140, 640 and the brushes 136, and may reduce a downtime of the machine with which the alternator 100 is associated. The oxide layer 150, 650 may reduce a frequency of replacement of the brushes 136 and/or the slip rings 140, 640, which may in turn reduce a cost and efforts associated with frequent replacement of the brushes 136 and/or the slip rings 140, 640.

Additionally, the oxide layer 150, 650 may be formed on existing alternators by replacing existing slip rings and the brushes with the brushes 136 and the slip rings 140, 640 made of the materials defined in the present disclosure. Further, the method 700 of forming the oxide layer 150, 650 may be simple and cost effective. Moreover, the oxide layer 150, 650 may be formed during the operation of the alternator 100. Thus, a separate process may not be required to form the oxide layers 150, 650.

Further, the material of the slip ring 140 i.e., the alloyed steel, and the slip ring 640 i.e., the carbon steel, including the coating 656 may lead to the formation of stable oxide layers 150, 650, respectively, that may provide improved wear resistance and strength against frictional forces. In some examples, the exemplary composition of the alloyed steel used for manufacturing the slip ring 140 as described in the present disclosure may provide improved wear resistance and strength against frictional forces.

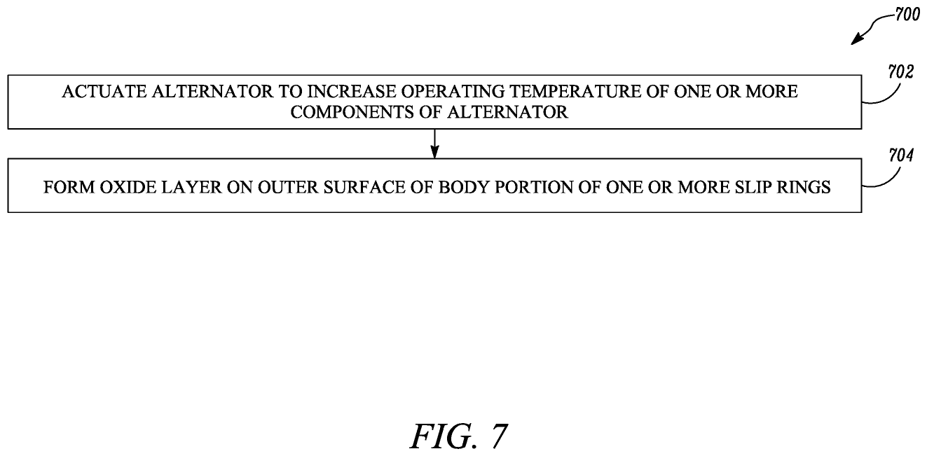

FIG. 7 illustrates a flowchart for the method 700 of forming the oxide layer 150, 650 on the one or more slip rings 140, 640 of the alternator 100. The alternator 100 includes the one or more brushes 136 that slidably contact the one or more slip rings 140, 640. At step 702, the alternator 100 is actuated to operate the alternator 100 to increase the operating temperature of the one or more components of the alternator 100. The one or more components of the alternator 100 includes the one or more slip rings 140.

Further, the material of the one or more slip rings 140, 640 is one or more of the alloyed steel and the carbon steel. Moreover, the body portion 642 includes the coating 656 disposed on the outer surface 644 of the body portion 642, such that the oxide layer 650 is formed on the coating 656. The material of the coating 656 is copper.

At step 704, the oxide layer 150, 650 is formed on the outer surface 144, 644 of the body portion 142, 642 of the one or more slip rings 140, 640. The oxide layer 150, 650 is non-uniform. Further, the oxide layer 150, 650 is formed on account of the thermal oxidation process of the one or more slip rings 140, 640 during the operation of the alternator 100. The thermal oxidation process for formation of the oxide layer 150, 650 initiates when the operating temperature of the one or more components of the alternator 100 lies within the predetermined temperature threshold range “R1”, “R2”. It should be noted that the operating temperature may be achieved based on the heat generated within the alternator 100. For example, the sliding contact between the brushes 136 and a corresponding slip ring 140, 640 may cause the one or more components of the alternator 100 to reach the operating temperature.

Moreover, the one or more current transfer passages 154 may be defined in the oxide layer 150, 650 based on the sliding contact between the one or more brushes 136 of the alternator 100 and the one or more slip rings 140, 640. The material of the one or more brushes 136 is graphite.

It may be desirable to perform one or more of the steps 702, 704 shown in FIG. 7 in an order different from that depicted. Furthermore, various steps 702, 704 could be performed together.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. An alternator comprising:
a housing;
a rotary shaft supported by the housing;
one or more brushes supported by the housing and radially spaced apart from the rotary shaft; and
a slip ring assembly coupled to the rotary shaft for rotating with the rotary shaft, wherein the slip ring assembly includes the one or more slip rings, such that one or more brushes slidably contact the one or more slip rings, the one or more slip rings including:
a body portion defining an outer surface; and
an oxide layer disposed on the outer surface of the body portion, wherein the oxide layer is non-uniform, wherein the oxide layer is formed on account of a thermal oxidation process of the one or more slip rings during an operation of the alternator, and wherein the thermal oxidation process for formation of the oxide layer on the one or more slip rings initiates when an operating temperature of one or more components of the alternator lies within a predetermined temperature threshold range.

2. The alternator of claim 1, wherein the one or more components of the alternator includes the one or more slip rings.

3. The alternator of claim 1, wherein a material of the one or more brushes is graphite.

4. The alternator of claim 1, wherein a material of the one or more slip rings is alloyed steel.

5. The alternator of claim 1, wherein a material of the one or more slip rings is carbon steel.

6. The alternator of claim 5, wherein the body portion includes a coating disposed on the outer surface of the body portion, such that the oxide layer is formed on the coating, and wherein a material of the coating is copper, the oxide layer being formed is copper oxide.

7. The alternator of claim 1, wherein the oxide layer includes one or more conducting spots.

8. The alternator of claim 7, wherein the oxide layer includes one or more current transfer passages, and wherein a force exerted on the one or more conducting spots based on a sliding contact between the one or more brushes and the one or more slip rings causes a formation of the one or more current transfer passages.

9. A slip ring assembly associated with an alternator, the slip ring assembly comprising:
one or more slip rings including:
a body portion defining an outer surface; and
an oxide layer disposed on the outer surface of the body portion, wherein the oxide layer is non-uniform, wherein the oxide layer is formed on account of a thermal oxidation process of the one or more slip rings during an operation of the alternator, and wherein the thermal oxidation process for formation of the oxide layer initiates when an operating temperature of one or more components of the alternator lies within a predetermined temperature threshold range.

10. The slip ring assembly of claim 9, wherein the alternator includes one or more brushes, the one or more brushes slidably contact the one or more slip rings, wherein a material of the one or more brushes is graphite.

11. The slip ring assembly of claim 9, wherein the one or more components of the alternator includes the one or more slip rings.

12. The slip ring assembly of claim 9, wherein a material of the one or more slip rings is alloyed steel.

13. The slip ring assembly of claim 9, wherein a material of the one or more slip rings is carbon steel.

14. The slip ring assembly of claim 13, wherein the body portion includes a coating disposed on the outer surface of the body portion, such that the oxide layer is formed on the coating, and wherein a material of the coating is copper.

15. The slip ring assembly of claim 9, wherein the oxide layer includes:
one or more conducting spots; and
one or more current transfer passages, wherein a force exerted on the one or more conducting spots based on a sliding contact between the one or more brushes and the one or more slip rings causes a formation of the one or more current transfer passages.

16. A method of forming an oxide layer on one or more slip rings of an alternator, wherein the alternator includes one or more brushes that slidably contacts the one or more slip rings, the method comprising:
actuating the alternator to increase an operating temperature of one or more components of the alternator; and
forming the oxide layer on an outer surface of a body portion of the one or more slip rings, wherein the oxide layer is non-uniform, wherein the oxide layer is formed on account of a thermal oxidation process of the one or more slip rings during an operation of the alternator, and wherein the thermal oxidation process for formation of the oxide layer initiates when the operating temperature of the one or more components of the alternator lies within a predetermined temperature threshold range.

17. The method of claim 16, wherein the one or more components of the alternator includes the one or more slip rings.

18. The method of claim 16, wherein a material of the one or more slip rings is at least one of alloyed steel and carbon steel.

19. The method of claim 16, wherein the body portion includes a coating disposed on the outer surface of the body portion, such that the oxide layer is formed on the coating, and wherein a material of the coating is copper, the oxide layer being formed is copper oxide.

20. The method of claim 16 further comprising defining one or more current transfer passages in the oxide layer based on a sliding contact between one or more brushes of the alternator and the one or more slip rings, wherein a material of the one or more brushes is graphite.
